(19) United States
(12) Patent Application Publication
(10) Pub. No.: US 2021/0229130 A1
(43) Pub. Date: Jul. 29, 2021

(54) MULTILAYER COATING FILM AND METHOD FOR FORMING MULTILAYER COATING FILM

(71) Applicant: KANSAI PAINT CO., LTD., Hyogo (JP)

(72) Inventor: Shigeru TOMIZAWA, Kanagawa (JP)

(73) Assignee: KANSAI PAINT CO., LTD., Hyogo (JP)

(21) Appl. No.: 17/155,423

(22) Filed: Jan. 22, 2021

(30) Foreign Application Priority Data
Jan. 24, 2020 (JP) 2020-009793
Nov. 27, 2020 (JP) 2020-196699

(51) Int. Cl. B05D 7/00; B05D 7/14; C09D 5/36; C09D 17/00; B05D 5/06

(52) U.S. Cl. CPC B05D 7/572; B05D 7/576; B05D 7/14; C09D 5/36; C09D 17/001; C09D 17/003; B05D 2508/00; B05D 5/066; B05D 2202/00; B05D 2420/01; B05D 2420/02; B05D 2420/03; B05D 2502/00; C09D 17/008

(57) ABSTRACT

Provided are a multilayer coating film with pearl luster that is bright in highlight and that has a small change in graininess due to difference in observation directions, and a method for forming the multilayer coating film. The multilayer coating film contains on a substrate in the following sequence a color-pigment-containing colored base coating film, an interference-pigment-containing effect base coating film, and a clear-coat coating film. The multilayer coating film has a Y value (Y5) in the XYZ color space of 300 or more. The multilayer coating film has a ratio of a 15° sparkle area Sa to a 45° sparkle area Sa of 7 or less.

### TECHNICAL FIELD

The present invention relates to a multilayer coating film and a method for forming a multilayer coating film.

### BACKGROUND ART

The main purpose of applying paint is to protect materials and to impart an excellent appearance to materials. With industrial products, great value is placed on excellent appearance, in particular color and texture, to enhance product appeal. Although the texture of industrial products desired by consumers varies, design with pearl luster has been in demand in areas such as automotive exterior panels, auto parts, and home appliances.

For example, PTL 1 discloses that a coating film with pearl luster can be formed by using an effect pigment dispersion that contains water, a rheology control agent (A), and a flake-effect pigment (B), the flake-effect pigment (B) being an interference pigment in which a transparent or translucent substrate is coated with a metal oxide, and the solids content of the effect pigment dispersion being 0.1 to 15 mass %.

### CITATION LIST

### Patent Literature

PTL 1: WO2018/012014

### SUMMARY OF INVENTION

### Technical Problem

Although PTL 1 provides a coating film with pearl luster, recent years have seen a further demand for a coating film with pearl luster that is bright in highlight and that has a small change in graininess due to difference in observation directions.

An object of the present invention is to provide a multilayer coating film with pearl luster that is bright in highlight, and that has a small change in graininess due to difference in observation directions, and a method for forming the multilayer coating film.

### Solution to Problem

In one aspect of the invention, a multilayer coating film is provided. The multilayer coating film comprises on a substrate in the following sequence
a color-pigment-containing colored base coating film,
an interference-pigment-containing effect base coating film, and
a clear-coat coating film,
the multilayer coating film having a Y value (Y5) of 300 or more,
the Y value indicating a luminance in an XYZ color space based on a spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film to be measured,
the multilayer coating film having a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction, and
the imaging device for taking the images of the surface of the multilayer coating film being disposed in the direction perpendicular to the planar direction of the surface of the multilayer coating film to be measured.

In one embodiment, the multilayer coating film has a lightness L* (110°) of 78 or more, wherein the lightness L* (110°) indicates a lightness L* as measured for light received at an angle of 110 degrees deviated from a specular angle toward a measurement light when the measurement light is illuminated on a surface of the multilayer coating film to be measured at an angle of 45 degrees with respect to an axis perpendicular to the surface of the multilayer coating film to be measured.

In another embodiment, the colored base coating film has a lightness L* (45°) of 85 or more, wherein the lightness L* (45°) indicates a lightness L* as measured for light received at an angle of 45 degrees deviated from a specular angle toward a measurement light when the measurement light is illuminated on a surface to be measured at an angle of 45 degrees with respect to an axis perpendicular to the surface to be measured.

In another embodiment, the effect base coating film has a thickness of 1.6 to 4 μm on a dry film basis.

In another aspect of the invention, a method for forming a multilayer coating film is provided. The method for forming a multilayer coating film comprises the following steps (1) to (4):

step (1) of applying a color-pigment-containing colored base paint (X) to a substrate to form a colored base coating film,

step (2) of applying an interference-pigment-containing effect base paint (Y) to the colored base coating film to form an effect base coating film,

step (3) of applying a clear-coat paint (Z) to the effect base coating film to form a clear-coat coating film, and

step (4) of separately or simultaneously heating the colored base coating film formed in step (1), the effect base coating film formed in step (2), and the clear-coat coating film formed in step (3) to cure the films,

wherein

the multilayer coating film has a Y value (Y5) of 300 or more, the Y value indicating a luminance in an XYZ color space based on a spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film to be measured; and

the multilayer coating film has a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction, and
the imaging device for taking the images of the surface of the multilayer coating film being disposed in the direction perpendicular to the planar direction of the surface of the multilayer coating film to be measured.

In one embodiment, the multilayer coating film has a lightness L* (110°) of 78 or more, the lightness L* (110°) indicating a lightness L* as measured for light received at an angle of 110 degrees deviated from a specular angle toward a measurement light when the measurement light is illuminated on a surface of the multilayer coating film to be measured at an angle of 45 degrees with respect to an axis perpendicular to the surface of the multilayer coating film to be measured.

In another embodiment, the colored base coating film has a lightness L* (45°) of 85 or more, the lightness L (45°) indicating a lightness L as measured for light received at an angle of 45 degrees deviated from a specular angle toward a measurement light when the measurement light is illuminated on a surface to be measured at an angle of 45 degrees with respect to an axis perpendicular to the surface to be measured.

In another embodiment, the effect base paint (Y) has a solids content of 0.1 to 9 mass % when subjected to coating.

In another embodiment, the effect base coating film has a thickness of 1.6 to 4 μm on a dry film basis.

### Advantageous Effects of Invention

According to the present invention, a multilayer coating film with pearl luster that is bright in highlight and that has a small change in graininess due to difference in observation directions is provided.

### BRIEF DESCRIPTION OF DRAWINGS

FIG. 1 is a schematic diagram that illustrates the positional relationship of illuminating light and an imaging device with respect to a measurement object 1.

FIG. 2 is a schematic diagram that explains lightness L* (110°).

### DESCRIPTION OF EMBODIMENTS

Below, the multilayer coating film according to the present invention is described in more detail.

The multilayer coating film according to the present invention comprises on a substrate in the following sequence
a color-pigment-containing colored base coating film,
an interference-pigment-containing effect base coating film, and
a clear-coat coating film,

the multilayer coating film having a Y value (Y5) of 300 or more,
the Y value indicating a luminance in an XYZ color space based on a spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film,

the multilayer coating film having a ratio of a 15° sparkle area Sa to a 45° sparkle area Sa, i.e., Sa(15°)/Sa(45°), of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction, and
the imaging device for taking the images of the surface of the multilayer coating film being disposed in the direction perpendicular to the planar direction of the surface of the multilayer coating film to be measured.

The Y value (Y5) refers to a luminance in the XYZ color space based on spectral reflectance measured for measurement light that illuminates a surface of a multilayer coating film to be measured at an angle of 45 degrees with respect to the axis perpendicular to the surface of the multilayer coating film to be measured and for light that is received at an angle of 5 degrees deviated from the specular angle toward the measurement light. In other words, the light received at an angle of 5 degrees deviated from the specular angle toward the measurement light is light shifted by 5 degrees toward the measurement light with respect to the specular angle.

The Y value (Y5) can be determined by performing measurement with a GCMS-4 goniometer (trade name; colorimeter produced by Murakami Color Research Laboratory Co., Ltd.).

A higher Y value (Y5) of a multilayer coating film indicates that the multilayer coating film has a design with pearl luster that is bright in highlight.

A Y value (Y5) of 300 or more, preferably 330 or more, and still more preferably 380 or more, can lead to a multilayer coating film with pearl luster that is bright in highlight.

“Highlight” refers to observing a multilayer coating film near specular reflection light.

The upper limit of the Y value (Y5) is, although not limited to, preferably 800 or less, and more preferably 650 or less.

The 45° sparkle area Sa and 15° sparkle area Sa are determined by disposing an imaging device for taking images of the surface of an object to be measured in the direction perpendicular to the planar direction of the surface of the object, taking the images with light illuminated on the surface of the multilayer coating film to be measured at an angle of 45 degrees and at an angle of 15 degrees with respect to a direction perpendicular to the planar direction by using the imaging device, and analyzing the obtained images with an image processing algorithm that uses a histogram of brightness levels. Examples of imaging devices for use include a CCD chip.

The 45° sparkle area Sa and 15° sparkle area Sa can be determined by performing measurement with a multi-angle colorimeter (trade name: BYK-mac i; produced by BYK).

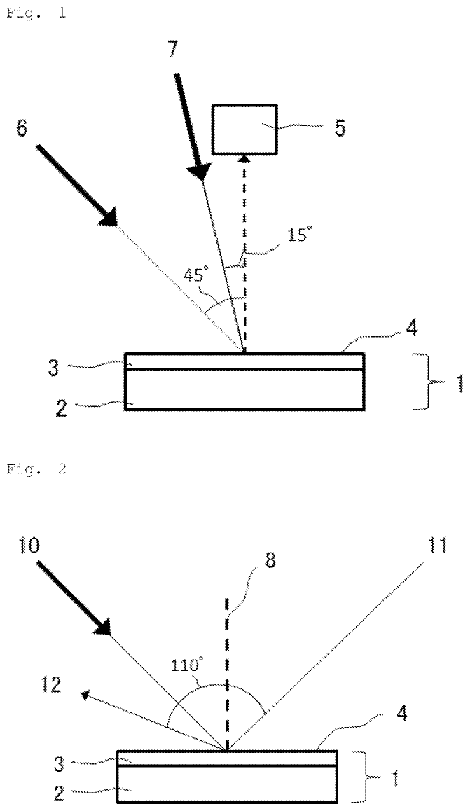

FIG. 1 illustrates the positional relationship of illuminating light and an imaging device with respect to a measurement object 1. The measurement object 1 is a substrate 2 on which a multilayer coating film 3 is applied, and the surface of the multilayer coating film 3 defines a measurement object surface 4. In the direction perpendicular to the planar direction of the measurement object surface 4, an imaging device 5 for taking images of the measurement object surface 4 is disposed. Images of the measurement object surface 4 are photographed with the imaging device 5 with light 6 illuminated on the measurement object surface 4 at an angle of 45 degrees perpendicular to the planar direction of the measurement object surface 4 and with light 7 illuminated on the measurement object surface 4 at an angle of 15 degrees with respect to the direction perpendicular to the planar direction of the measurement object surface 4. The 45° sparkle area Sa and 15° sparkle area Sa are determined based on the obtained images.

A ratio of the 15° sparkle area Sa to the 45° sparkle area Sa of 7 or less indicates a design with a small change in graininess due to difference in observation directions.

A ratio of the 15° sparkle area Sa to the 45° sparkle area Sa of preferably 5 or less, more preferably 4 or less, and still more preferably 3 or less, can lead to a multilayer coating film with a small change in graininess due to difference in observation directions.

From the standpoint of, for example, obtaining a multilayer coating film with pearl luster, the multilayer coating film preferably has a lightness L* (110°) of 78 or more, more preferably 80 or more, and still more preferably 82 or more.

As used herein, “lightness L* (110°)” refers to a lightness L* as measured for light received at an angle of 110 degrees deviated from a specular angle toward a measurement light when the measurement light is illuminated on the surface of the object to be measured at an angle of 45 degrees with respect to the axis perpendicular to the surface of the object to be measured, and is defined as a value of lightness computed from a spectral reflectance using a multi-angle spectrophotometer (trade name: MA-68II; produced by X-Rite).

With reference to FIG. 2, lightness L* (110°) indicates a lightness L* as determined by emitting measurement light 10 at an angle of 45 degrees with respect to an axis 8 perpendicular to the measurement object surface 4, receiving light 12 at an angle of 110 degrees deviated from a specular angle 11 toward the measurement light 10, and measuring the light 12.

### Configuration of Multilayer Coating Film

Below, the configuration of the multilayer coating film according to the present invention is described. The multilayer coating film according to the present invention is formed on a substrate described below.

### Substrate

Examples of substrates include exterior panel parts of vehicle bodies, such as passenger cars, trucks, motorcycles, and buses; vehicle components; and exterior panel parts of household electric appliances, such as mobile phones and audio equipment. Of these, exterior panel parts of vehicle bodies and vehicle components are preferable.

The material of these substrates is not particularly limited. Examples of the material include metallic materials, such as iron, aluminum, brass, copper, tin, stainless steel, galvanized steel, and steel plated with zinc alloys (e.g., Zn—Al, Zn—Ni, Zn—Fe); plastic materials, such as various types of fiber-reinforced plastics (FRP), polyethylene resins, polypropylene resins, acrylonitrile-butadiene-styrene (ABS) resins, polyamide resins, acrylic resins, vinylidene chloride resins, polycarbonate resins, polyurethane resins, epoxy resins, and like resins; inorganic materials, such as glass, cement, and concrete; wood; and textile materials, such as paper and cloth. Of these materials, metallic materials and plastic materials are preferable.

The substrate to which the multilayer coating film is applied also includes exterior panel parts of vehicle bodies, vehicle components, household electric appliances, and metal substrates thereof, such as steel plates, whose metal surfaces are subjected to a surface treatment, such as phosphate treatment, chromate treatment, or composite oxide treatment.

The object may or may not be surface-treated, and one or more coating films may be further formed on the object. For example, the substrate as a base material may optionally be surface-treated, and an undercoating film may be formed on the substrate; an intermediate coating film may be further formed on the undercoating film. For example, when the substrate is a vehicle body, the undercoating film and the intermediate coating film can be formed by using known undercoat and intermediate paints commonly used on coating vehicle bodies.

Examples of undercoat paints for forming an undercoating film include electrodeposition paints, and preferably cationic electrodeposition paints. Examples of intermediate paints for forming an intermediate coating film include paints prepared by using a base resin, such as an acrylic resin, polyester resin, alkyd resin, urethane resin, or epoxy resin that contains a crosslinkable functional group (e.g., a carboxyl or hydroxyl group); an amino resin, such as melamine resin or urea resin; and a crosslinking agent, such as a blocked or unblocked polyisocyanate compound, together with a pigment, a thickener, and other optional components.

In the present specification, the phrase “applying a colored base paint (X) to a substrate” includes not only the case in which the colored base paint (X) is directly applied to the substrate, but also the case in which the colored base paint (X) is applied after the substrate is surface-treated and/or after one or more additional layers, such as an undercoating film and/or an intermediate coating film, are formed on the substrate.

### Colored Base Coating Film

The colored base coating film contains a color pigment.

The colored base coating film is formed by applying a colored base paint (X).

The colored base paint (X) is a paint that contains a color pigment and that preferably further contains a resin component and a medium containing water and/or an organic solvent.

Examples of color pigments include titanium oxide, zinc oxide, carbon black, molybdenum red, Prussian blue, cobalt blue, azo pigments, phthalocyanine pigments, quinacridone pigments, isoindoline pigments, threne pigments, perylene pigments, dioxazine pigments, and diketopyrrolopyrrole pigments. Of these, from the standpoint of, for example, obtaining a multilayer coating film with undercoat hiding power and pearl luster, titanium oxide is preferable.

From the standpoint of, for example, obtaining a multilayer coating film with undercoat hiding power and pearl luster, the content of the color pigment is, on a solids basis, preferably 1 to 150 parts by mass, and more preferably 10 to 130 parts by mass, per 100 parts by mass of the resin solids of the colored base paint (X).

The resin component typically contains a base resin and a curing agent, and the resin component for use may be known resins or compounds commonly used in the art. Examples of base resins include acrylic resins, polyester resins, epoxy resins, and polyurethane resins. Examples of curing agents include amino resins, polyisocyanate compounds, and blocked polyisocyanate compounds.

The colored base paint (X) may be an aqueous paint or a solvent-based paint. However, from the standpoint of reducing the burden on the environment, the colored paint (X) is preferably an aqueous paint. When the colored base paint (X) is an aqueous paint, the base resin can be made soluble in water or dispersed in water by using a resin containing a hydrophilic group, such as a carboxyl group, a hydroxyl group, a methylol group, an amino group, a sulfonic acid group, or a polyoxyethylene group, most preferably a carboxyl group, in an amount sufficient for making the resin soluble in water or dispersed in water; and by neutralizing the hydrophilic group.

The colored base paint (X) may suitably contain a V absorber, a light stabilizer, an antifoaming agent, a thickener, a surface-adjusting agent, and a pigment other than the color pigment, if necessary.

Examples of pigments other than the color pigment include extender pigments and effect pigments. These pigments may be used singly, or in a combination of two or more.

Examples of extender pigments include clay, kaolin, barium sulfate, barium carbonate, calcium carbonate, talc, silica, and alumina white. Of these, barium sulfate and/or talc is preferable for use. In particular, to obtain a multilayer coating film with an appearance with excellent smoothness, it is preferable to use barium sulfate with an average primary particle size of 1 μm or less, and particularly preferably 0.01 to 0.8 μm, as an extender pigment.

In the present specification, the average primary particle size of barium sulfate is determined by observing barium sulfate with a scanning electron microscope and averaging the maximum diameter of 20 barium sulfate particles on a straight line drawn at random on an electron microscope photograph.

When the colored base paint (X) contains the extender pigment described above, the amount of the extender pigment is preferably 30 parts by mass or less, and more preferably 0.1 to 20 parts by mass, per 100 parts by mass of the resin solids in the colored base paint.

The colored base paint (X) can be applied by a typical method. Examples include methods such as air spray coating, airless spray coating, and rotary-atomization coating. When applying the colored base paint, electrostatic charge may optionally be applied. Of such methods, rotary-atomization electrostatic coating and air-spray electrostatic coating are preferable, with rotary-atomization electrostatic coating being particularly preferable.

When air spray coating, airless spray coating, or rotary-atomization coating is performed, it is preferred that the colored base paint be adjusted to have a solids content and a viscosity suitable for coating by adding water and/or an organic solvent, with optional additives such as a rheology control agent and an antifoaming agent.

The colored base paint (X) has a solids content of 10 to 60 mass %, preferably 15 to 55 mass %, and still more preferably 20 to 50 mass %. It is also preferred that the viscosity of the colored base paint (X) be suitably adjusted with water and/or an organic solvent to a range suitable for coating, which is typically 500 to 5000 mPa·s as measured with a Brookfield viscometer at a rotational speed of 6 rpm at 20° C.

From the standpoint of, for example, obtaining a multilayer coating film with undercoat hiding power and pearl luster, the colored base coating film formed from the colored base paint (X) preferably has a lightness L* (45°) of 85 or more, and more preferably 90 or more, on a cured colored base coating film basis.

As used herein, “lightness L* (45°)” indicates a lightness L* as measured or light received at an angle of 45 degrees deviated from the specular angle toward a measurement light when the measurement light is illuminated to the surface of an object to be measured at an angle of 45 degrees with respect to the axis perpendicular to the surface of an object to be measured. Lightness L* (45°) is defined as a value of lightness calculated from a spectral reflectance with a multi-angle spectrophotometer (trade name: MA-68II; produced by X-Rite).

From the standpoint of, for example, obtaining a multilayer coating film with undercoat hiding power and pearl luster, the colored base coating film has a thickness of preferably about 5.0 to 40 μm, more preferably 8.0 to 35 μm, and still more preferably about 10 to 30 μm, on a cured film basis.

### Effect Base Coating Film

The effect base coating film contains an interference pigment.

The effect base coating film is formed by applying an effect base paint (Y).

The effect base paint (Y) contains an interference pigment, and preferably further contains a rheology control agent, a resin component, and water.

The interference pigment may be, for example, an effect pigment prepared by coating the surface of a transparent or translucent flake-substrate, such as a metal oxide (e.g., natural mica, synthetic mica, glass, silica, iron oxide, and aluminum oxide), with another metal oxide that has a refractive index different from that of the substrate. The interference pigment for use may be a single interference pigment or a combination of two or more. In this specification, a transparent substrate means a substrate that transmits at least 90% of visible light. A translucent substrate means a substrate that transmits at least 10%, and less than 90% of visible light.

Natural mica is a flaky base material obtained by pulverizing mica from ore. Synthetic mica is synthesized by heating an industrial material, such as SiO₂, MgO, Al₂O₃, K₂SiF₆, or Na₂SiF₆, to melt the material at a high temperature of about 1500° C., and by cooling the melt for crystallization. When compared with natural mica, synthetic mica contains a smaller amount of impurities, and has a more uniform size and thickness. Specific examples of synthetic mica base materials include fluorophlogopite (KMg₃AlSi₃O₁₀F₂), potassium tetrasilicon mica (KMg_{2.5}AlSi₄O₁₀F₂), sodium tetrasilicon mica (NaMg_{2.5}AlSi₄O₁₀F₂), Na taeniolite (NaMg₂LiSi₄O₁₀F₂), and LiNa taeniolite (LiMg₂LiSi₄O₁₀F₂).

Examples of metal oxides for coating a substrate include titanium oxide and iron oxide. The interference pigment can express different interference colors, depending on the thickness of the metal oxide.

Specifically, examples of interference pigments include the following metal-oxide-coated mica pigments, metal-oxide-coated alumina flake pigments, metal-oxide-coated glass flake pigments, and metal-oxide-coated silica flake pigments.

The metal-oxide-coated mica pigments are a pigment obtained by coating the surface of a base material, such as natural mica or synthetic mica, with a metal oxide.

The metal-oxide-coated alumina flake pigments are obtained by coating the surface of alumina flakes used as a base material with a metal oxide. Alumina flakes refer to flaky (thin) aluminum oxides, which are transparent and colorless. Alumina flakes do not necessarily consist of only aluminum oxide, and may contain other metal oxides.

The metal-oxide-coated glass flake pigments are obtained by coating the surface of flake glass used as a base material with a metal oxide. The metal-oxide-coated glass flake pigments cause intense light reflection because of the smooth surface of the base material.

The metal-oxide-coated silica flake pigments are obtained by coating flake silica, which is a base material with a smooth surface and a uniform thickness, with a metal oxide.

From the standpoint of obtaining a multilayer coating film with pearl luster that is bright in highlight, and that has a small change in graininess due to difference in observation directions, the interference pigment is preferably at least one interference pigment selected from the group consisting of a metal-oxide-coated mica pigment and a metal-oxide-coated alumina flake pigment.

From the standpoint of, for example, obtaining a multilayer coating film with pearl luster that is bright in highlight and has a small change in graininess due to difference in observation directions, the interference pigment has an average particle size of preferably 5 to 20 μm, more preferably 6 to 18 μm, and particularly preferably 7 to 12 μm.

In the present specification, the average particle size of the interference pigment refers to an average particle size (D50) on a volume basis, and is a value at 50% of the particle size distribution measured with a laser diffraction particle size distribution analyzer.

From the standpoint of, for example, obtaining a multilayer coating film with pearl luster that is bright in highlight and has a small change in graininess due to difference in observation directions, the interference pigment preferably has a thickness of 0.05 to 0.8 μm, and particularly preferably 0.1 to 0.5 μm.

In the present specification, the thickness of the interference pigment is defined as an average value of 100 or more measured values determined by observing the cross-section of a coating film containing the interference pigment with an optical microscope, and measuring the minor axis of the interference pigment particles by using image-processing software.

From the standpoint of, for example, obtaining a multilayer coating film with pearl luster that is bright in highlight and has a small change in graininess due to difference in observation directions, the content of the interference pigment in the effect base paint (Y) is, on a solids basis, preferably 30 to 85 parts by mass, more preferably 40 to 80 parts by mass, and still more preferably 45 to 75 parts by mass, per 100 parts by mass of the solids of the effect base paint (Y).

In the present specification, “solids” refers to non-volatile components, and refers to the residues that remain after volatile components such as water and an organic solvent are removed from a sample. The solids content can be calculated by multiplying the mass of a sample by the solids concentration. The solids concentration can be measured by dividing the mass of residues obtained by drying 3 g of a sample at 105° C. for 3 hours by the mass of the sample before drying.

The rheology control agent for use may be a known rheology control agent. Examples include silica-based fine powder, mineral-based rheology control agents, barium sulfate fine powder, polyamide-based rheology control agents, organic resin fine-particle rheology control agents, diurea-based rheology control agents, urethane-associated rheology control agents, polyacrylic-acid-based rheology control agents, which are acrylic swelling agents, and cellulose-based rheology control agents. In particular, from the standpoint of, for example, obtaining a multilayer coating film with pearl luster that is bright in highlight and has a small change in graininess due to difference in observation directions, a mineral-based rheology control agent, a polyacrylic acid-based rheology control agent, and a cellulose-based rheology control agent are preferable, and a cellulose-based rheology control agent is particularly preferable. These rheology control agents may be used singly or in a combination of two or more.

Examples of mineral-based rheology control agents include swelling laminar silicate that has a 2:1 crystalline structure. Specific examples include smectite clay minerals, such as natural or synthetic montmorillonite, saponite, hectorite, stevensite, beidellite, nontronite, bentonite, and laponite; swelling mica clay minerals, such as Na-type tetrasilicic fluorine mica, Li-type tetrasilicic fluorine mica, Na salt-type fluorine taeniolite, and Li-type fluorine taeniolite; vermiculite; substituted products or derivatives thereof; and mixtures thereof.

Examples of polyacrylic-acid-based rheology control agents include sodium polyacrylate and polyacrylic acid-(meth)acrylic acid ester copolymers.

Examples of commercial products of polyacrylic-acid-based rheology control agents include Primal ASE-60, Primal TT615, and Primal RM5 (trade names; produced by The Dow Chemical Company); and SN Thickener 613, SN Thickener 618, SN Thickener 630, SN Thickener 634, and SN Thickener 636 (trade names; produced by San Nopco Limited).

The acid value of the solids of the polyacrylic-acid-based rheology control agent is preferably 30 to 300 mg KOH/g, and more preferably 80 to 280 mg KOH/g.

Examples of cellulose-based rheology control agents include carboxymethylcellulose, methylcellulose, hydroxyethylcellulose, hydroxyethylmethylcellulose, hydroxypropylmethylcellulose, methylcellulose, and cellulose nanofibers. Of these, cellulose nanofibers are preferable, from the standpoint of, for example, obtaining a multilayer coating film with pearl luster that is bright in highlight and has a small change in graininess due to difference in observation directions.

The cellulose nanofibers may also be referred to as “cellulose nanofibrils,” “fibrillated cellulose,” or “nanocellulose crystals.”

The cellulose nanofibers have a number average fiber diameter of preferably 2 to 500 nm, more preferably 2 to 250 nm, and still more preferably 2 to 150 nm, and also have a number average fiber length of preferably 0.1 to 20 μm, more preferably 0.1 to 15 μm, and still more preferably 0.1 to 10 μm from the standpoint of, for example, obtaining a multilayer coating film with pearl luster that is bright in highlight and has a small change in graininess due to difference in observation directions.

The number average fiber diameter and number average fiber length are measured and calculated from, for example, an image obtained by subjecting a sample (cellulose nanofibers diluted with water) to a dispersion treatment, casting the sample on a grid coated with a carbon film that has been subjected to hydrophilic treatment, and observing the sample with a transmission electron microscope (TEM).

The cellulose nanofibers for use may be those obtained by defibrating a cellulose material and stabilizing it in water.

The cellulose material as used here refers to cellulose-main materials in various forms. Specific examples include pulp (e.g., grass-plant-derived pulp, such as wood pulp, jute, Manila hemp, and kenaf); natural cellulose, such as cellulose produced by microorganisms; regenerated cellulose obtained by dissolving cellulose in a copper ammonia solution or a solvent such as a morpholine derivative, and subjecting the dissolved cellulose to spinning; and fine cellulose obtained by subjecting the cellulose material to mechanical treatment, such as hydrolysis, alkali hydrolysis, enzymatic decomposition, blasting treatment, or vibration ball milling, to depolymerize the cellulose.

Cellulose nanofibers for use may be anionically modified cellulose nanofibers. Examples of anionically modified cellulose nanofibers include carboxylated cellulose nanofibers, carboxymethylated cellulose nanofibers, sulfonic acid group-containing cellulose nanofibers, and phosphate-group-containing cellulose nanofibers. The anionically modified cellulose nanofibers can be obtained, for example, by incorporating functional groups such as carboxyl groups and carboxymethyl groups into a cellulose material by a known method, washing the obtained modified cellulose to prepare a dispersion of the modified cellulose, and defibrating this dispersion. The carboxylated cellulose is also referred to as “oxidized cellulose.”

The oxidized cellulose can be obtained, for example, by oxidizing the cellulose material in water by using an oxidizing agent in the presence of a compound selected from the group consisting of an N-oxyl compound, a bromide, an iodide, and a mixture thereof.

Examples of commercially available products of cellulose nanofibers include Rheocrysta (registered trademark) produced by DKS Co., Ltd., and Aurovisc (registered trademark) produced by Oji Holdings Corporation.

From the standpoint of, for example, obtaining a multilayer coating film with pearl luster that is bright in highlight and has a small change in graininess due to difference in observation directions, the content of the rheology control agent in the effect base paint (Y) is, on a solids basis, preferably 0.1 to 97 parts by mass, more preferably 0.5 to 80 parts by mass, and still more preferably 1 to 60 parts by mass, per 100 parts by mass of the total solids of the effect base paint (Y).

The resin component for use may be known resins or compounds commonly used in the art. Specific examples of resin components include acrylic resins, polyester resins, epoxy resins, polyurethane resins, amino resins, polyisocyanate compounds, and blocked polyisocyanate compounds.

The resin component can be made soluble in water or dispersed in water by using a resin containing a hydrophilic group, such as a carboxyl group, a hydroxyl group, a methylol group, an amino group, a sulfonic acid group, or a polyoxyethylene group, most preferably a carboxyl group, in an amount sufficient for making the resin soluble in water or dispersed in water; and by neutralizing the hydrophilic group.

The effect base paint (Y) preferably further contains a surface-adjusting agent.

The surface-adjusting agent is for use in facilitating uniform orientation of the interference pigment dispersed in water on an object when the effect base paint (Y) is applied to the object.

The surface-adjusting agent for use may be a known surface-adjusting agent.

Examples of surface-adjusting agents include surface-adjusting agents such as silicone-based surface-adjusting agents, acrylic-based surface-adjusting agents, vinyl-based surface-adjusting agents, fluorine-based surface-adjusting agents, and acetylene-diol-based surface-adjusting agents. In particular, from the standpoint of orientation of the interference pigment, acetylene-diol-based surface-adjusting agents are preferable.

These surface-adjusting agents may be used singly, or in a combination of two or more.

Examples of commercially available surface-adjusting agents include the Dynol series, Surfynol series, and Tego series (produced by Evonik Industries AG), BYK series (produced by BYK-Chemie), Glanol series and Polyflow series (produced by Kyoeisha Chemical Co., Ltd.), and Disparlon series (produced by Kusumoto Chemicals, Ltd.).

When the effect base paint (Y) contains a surface-adjusting agent, the appropriate content of the surface-adjusting agent is, on a solids basis, preferably 1 to 400 parts by mass, more preferably 2 to 100 parts by mass, and still more preferably 5 to 60 parts by mass, per 100 parts by mass of the total solids of the effect pigment in the effect base paint (Y), from the standpoint of, for example, obtaining a multilayer coating film with pearl luster that is bright in highlight and has a small change in graininess due to difference in observation directions.

From the standpoint of, for example, obtaining a multilayer coating film with pearl luster that is bright in highlight and has a small change in graininess due to difference in observation directions, the appropriate solids content of the surface-adjusting agent is preferably 0.1 to 40 parts by mass, more preferably 0.2 to 35 parts by mass, and still more preferably 0.3 to 30 parts by mass, per 100 parts by mass of the total solids of the effect base paint (Y).

The effect base paint (Y) may further optionally contain, for example, a pigment other than the interference pigment, an organic solvent, a pigment dispersant, a pigment derivative, an anti-settling agent, an antifoaming agent, an U absorber, or a light stabilizer.

Examples of pigments other than the interference pigment include color pigments, extender pigments, vapor deposition metal flake pigments, and aluminum flake pigments.

Specific examples of coloring pigments include, although not particularly limited to, organic pigments, such as benzimidazolone pigments, pyrazolone pigments, azo pigments, quinacridone pigments, diketopyrrolopyrrole pigments, perylene pigments, perinone pigments, isoindoline pigments, isoindolinone pigments, metal chelate azo pigments, phthalocyanine pigments, indanthrone pigments, dioxazine pigments, threne pigments, and indigo pigments; composite-oxide inorganic pigments; and carbon black pigments. These pigments may be used singly, or in a combination of two or more.

Examples of extender pigments include talc, silica, calcium carbonate, barium sulfate, and zinc white (zinc oxide).

The effect base paint (Y) is prepared by mixing and dispersing the above components. From the standpoint of, for example, obtaining a multilayer coating film with pearl luster that is bright in highlight and has a small change in graininess due to difference in observation directions, the effect base paint (Y) has a solids content of preferably 0.1 to 9 mass %, and more preferably 1 to 9 mass % when subjected to coating. The viscosity of the effect base paint (Y) as measured at a temperature of 20° C. with a Brookfield viscometer at 60 rpm after 1 minute (also referred to as the “B60 viscosity” in this specification) is preferably 50 to 900 mPa·s, and more preferably 100 to 800 mPa·s, from the standpoint of, for example, obtaining a multilayer coating film with pearl luster that is bright in highlight and has a small change in graininess due to difference in observation directions. The viscometer for use is a Vismetron VDA digital viscometer (Shibaura System Co., Ltd.; Brookfield viscometer).

The effect base paint (Y) can be applied by a method such as electrostatic spraying, air spraying, or airless spraying, and particularly preferably with rotary-atomization electrostatic spraying.

The film thickness of the effect base coating film on a dry film basis is preferably 1.6 to 4 μm, more preferably 1.8 to 3.8 μm, and particularly preferably 2.1 to 3.5 μm, from the standpoint of, for example, obtaining a multilayer coating film with pearl luster that is bright in highlight and has a small change in graininess due to difference in observation directions.

### Clear-Coat Coating Film

The clear-coat coating film is formed by applying a clear-coat paint (Z).

The clear-coat paint (Z) may be a single-component clear paint containing a base resin and a curing agent, or a two-component clear-coat paint containing a hydroxy-containing resin and a polyisocyanate compound.

The clear-coat paint (Z) is preferably a two-component clear-coat paint containing a hydroxy-containing resin and a polyisocyanate compound, from the standpoint of the adhesion of the obtained multilayer coating film.

The hydroxy-containing resin for use may be a known resin that has a hydroxyl group without any limitation. Examples of hydroxy-containing resins include hydroxy-containing acrylic resins, hydroxy-containing polyester resins, hydroxy-containing polyether resins, and hydroxy-containing polyurethane resins; preferably hydroxy-containing acrylic resins and hydroxy-containing polyester resins; and particularly preferably hydroxy-containing acrylic resins.

The hydroxy-containing acrylic resin has a hydroxy value of preferably 80 to 200 mg KOH/g, and more preferably 100 to 180 mg KOH/g. A hydroxy value of 80 mg KOH/g or more leads to sufficient scratch resistance due to the high crosslinking density. A hydroxy value of 200 mg KOH/g or less enables the coating film to satisfy water resistance.

The hydroxy-containing acrylic resin has a weight average molecular weight of preferably 2500 to 40000, and more preferably 5000 to 30000. A weight average molecular weight of 2500 or more leads to satisfying the coating film properties, such as acid resistance. A weight average molecular weight of 40000 or less enables the coating film to have sufficient smoothness, thus resulting in satisfactory appearance.

In this specification, the average molecular weight refers to a value calculated from a chromatogram measured by gel permeation chromatography based on the molecular weight of standard polystyrene. For the gel permeation chromatography, HLC8120GPC (produced by Tosoh Corporation) was used. The measurement was conducted using four columns: TSKgel G-4000HXL, TSKgel G-3000HXL, TSKgel G-2500HXL, and TSKgel G-2000HXL (trade names, all produced by Tosoh Corporation) under the following conditions: mobile phase: tetrahydrofuran; measuring temperature: 40° C.; flow rate: 1 cc/min; and detector: RI.

The glass transition temperature of the hydroxy-containing acrylic resin is preferably −20° C. to 70° C., and particularly preferably −10° C. to 50° C. A glass transition temperature of −20° C. or more leads to sufficient coating film hardness. A glass transition temperature of 70° C. or less enables the coating film to have satisfactory smoothness of the coating surface.

A polyisocyanate compound is a compound having at least two isocyanate groups per molecule. Examples include aliphatic polyisocyanates, alicyclic polyisocyanates, aromatic-aliphatic polyisocyanates, aromatic polyisocyanates, and derivatives of these polyisocyanates. These polyisocyanate compounds may be used singly, or in a combination of two or more.

When the clear-coat paint (Z) is a two-component clear-coat paint as described above, the equivalent ratio of the isocyanate groups in the polyisocyanate compound to the hydroxyl groups in the hydroxy-containing resin (NCO/OH) is preferably 0.5 to 2, and more preferably 0.8 to 1.5, from the standpoint of, for example, curability and scratch resistance of the coating film.

The combination of the base resin and the curing agent in a one-component clear-coat paint may be, for example, a combination of a carboxy-containing resin and an epoxy-containing resin, a combination of a hydroxy-containing resin and a blocked polyisocyanate compound, and a combination of a hydroxy-containing resin and a melamine resin.

The clear-coat paint (Z) may further optionally contain a solvent, such as water and an organic solvent, and additives, such as a curing catalyst, an antifoaming agent, a UV absorbing agent, a light stabilizer, a thickening agent, a surface-adjusting agent, and a pigment.

The form of the clear-coat paint (Z) is not particularly limited. The clear-coat paint (Z) for use is typically an organic-solvent-based paint composition. Examples of organic solvents for use in this case include various organic solvents for paints, such as aromatic or aliphatic hydrocarbon solvents, ester solvents, ketone solvents, and ether solvents.

The organic solvent for use may be a solvent used in the preparation of, for example, a hydroxy-containing resin as is; or such a solvent that further contains other organic solvents.

The clear-coat paint (Z) has a solids concentration of preferably about 30 to 70 mass %, and more preferably about 40 to 60 mass %.

Coating of the clear-coat paint (Z) is not particularly limited. For example, the clear-coat paint (Z) can be applied by a coating method, such as air spray coating, airless spray coating, rotary-atomization coating, or curtain coating. In these coating methods, electrostatic charge may optionally be applied.

Of these, rotary-atomization coating using electrostatic charge is preferable. Typically, the amount of the applied clear-coat paint (Z) is preferably an amount that results in a cured film thickness of about 10 to 50 μm.

When the clear-coat paint (Z) is applied, it is preferable to suitably adjust the viscosity of the clear-coat paint (Z) to fall within a range suitable for the coating method. For example, for rotary-atomization coating using electrostatic charge, it is preferable to suitably adjust the viscosity of the clear-coat paint (Z) to fall within a range of about 15 to 60 seconds as measured with a Ford cup No. 4 viscometer at 20° C. using a solvent, such as an organic solvent.

### Method for Forming a Multilayer Coating Film

The method for forming a multilayer coating film according to the present invention includes the following steps (1) to (4):

step (1) of applying a color-pigment-containing colored base paint (X) to a substrate to form a colored base coating film,
step (2) of applying an interference-pigment-containing effect base paint (Y) to the colored base coating film to form an effect base coating film,
step (3) of applying a clear-coat paint (Z) to the effect base coating film to form a clear-coat coating film, and
step (4) of heating the colored base coating film formed in step (1), the effect base coating film formed in step (2), and the clear-coat coating film formed in step (3) separately or simultaneously to cure these films.

From the standpoint of shortening the steps, the colored base coating film, the effect base coating film, and the clear-coat coating film are preferably heated simultaneously to cure these films.

Heating can be performed with a known technique, such as a hot-blast furnace, an electric furnace, or an infrared-guided heating furnace. The heating temperature is preferably 70 to 150° C., and more preferably 80 to 140° C. The heating time is not particularly limited, and is preferably 10 to 40 minutes, and more preferably 20 to 30 minutes.

The present invention includes the following subject matter.

### Item 1.

A multilayer coating film comprising on a substrate in the following sequence
a color-pigment-containing colored base coating film,
an interference-pigment-containing effect base coating film, and
a clear-coat coating film,

the multilayer coating film having a Y value (Y5) of 300 or more,
the Y value indicating a luminance in an XYZ color space based on a spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film to be measured,

the multilayer coating film having a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction, and
the imaging device for taking the images of the surface of the multilayer coating film being disposed in the direction perpendicular to the planar direction of the surface of the multilayer coating film to be measured.

### Item 2.

The multilayer coating film according to Item 1, which has a lightness L* (110°) of 78 or more, wherein the lightness L* (110°) indicates a lightness L* as measured for light received at an angle of 110 degrees deviated from a specular angle toward a measurement light when the measurement light is illuminated on a surface of the multilayer coating film to be measured at an angle of 45 degrees with respect to an axis perpendicular to the surface of the multilayer coating film to be measured.

### Item 3.

The multilayer coating film according to Item 1 or 2, wherein the colored base coating film has a lightness L* (45°) of 85 or more, wherein the lightness L* (45°) indicates a lightness L* as measured for light received at an angle of 45 degrees deviated from a specular angle toward a measurement light when the measurement light illuminated on a surface to be measured at an angle of 45 degrees with respect to an axis perpendicular to the surface to be measured.

### Item 4.

The multilayer coating film according to any one of Items 1 to 3, wherein the color pigment contains titanium oxide.

### Item 5.

The multilayer coating film according to any one of Items 1 to 4, wherein the colored base coating film is formed from a colored base paint containing a base resin selected from the group consisting of an acrylic resin, a polyester resin, an epoxy resin, and a polyurethane resin.

### Item 6.

The multilayer coating film according to Item 5, wherein the colored base coating film is formed from a colored base paint containing a curing agent selected from the group consisting of an amino resin, a polyisocyanate compound, and a blocked polyisocyanate compound.

### Item 7.

The multilayer coating film according to any one of Items 1 to 6, wherein the colored base coating film has a thickness of 5.0 to 40 μm on a dry film basis.

### Item 8.

The multilayer coating film according to any one of Items 1 to 7, wherein the interference pigment contains at least one interference pigment selected from the group consisting of a metal-oxide-coated mica pigment and a metal-oxide-coated alumina flake pigment.

### Item 9.

The multilayer coating film according to any one of Items 1 to 8, wherein the effect base coating film further contains a rheology control agent.

### Item 10.

The multilayer coating film according to Item 9, wherein the rheology control agent is at least one member selected from the group consisting of a silica-based fine powder, a mineral-based rheology control agent, a barium sulfate fine powder, a polyamide-based rheology control agent, an organic-resin-fine-particle rheology control agent, a diurea-based rheology control agent, an urethane-associated rheology control agent, a polyacrylic-acid-based rheology control agent, and a cellulose-based rheology control agent.

### Item 11.

The multilayer coating film according to Item 9 or 10, wherein the rheology control agent contains a cellulose nanofiber.

### Item 12.

The multilayer coating film according to any one of Items 1 to 11, wherein the effect base coating film further contains a resin component.

### Item 13.

The multilayer coating film according to any one of Items 1 to 12, wherein the effect base coating film further contains a surface-adjusting agent.

### Item 14.

The multilayer coating film according to any one of Items 1 to 13, wherein the effect base coating film has a thickness of 1.6 to 4 μm on a dry film basis.

### Item 15.

The multilayer coating film according to any one of Items 1 to 14, wherein the clear-coat coating film is formed from a one-component clear-coat paint containing a base resin and a curing agent or a two-component clear-coat paint containing a hydroxy-containing resin and a polyisocyanate compound.

### Item 16.

The multilayer coating film according to any one of Items 1 to 15, wherein the clear-coat coating film has a thickness of 10 to 50 μm.

### Item 17.

A method for forming a multilayer coating film comprising the following steps (1) to (4):

step (1) of applying a color-pigment-containing colored base paint (X) to a substrate to form a colored base coating film,

step (2) of applying an interference-pigment-containing effect base paint (Y) to the colored base coating film to form an effect base coating film,

step (3) of applying a clear-coat paint (Z) to the effect base coating film to form a clear-coat coating film, and

step (4) of separately or simultaneously heating the colored base coating film formed in step (1), the effect base coating film formed in step (2), and the clear-coat coating film formed in step (3) to cure the films,

wherein

the multilayer coating film has a Y value (Y5) of 300 or more, the Y value indicating a luminance in an XYZ color space based on spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film to be measured; and

the multilayer coating film has a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction,
the imaging device for taking the images of the surface of the multilayer coating film being disposed in the direction perpendicular to the planar direction of the surface of the multilayer coating film to be measured.

### Item 18.

The method for forming a multilayer coating film according to Item 17, wherein the multilayer coating film has a lightness L* (110°) of 78 or more, the lightness L* (110°) indicating a lightness L* as measured for light received at an angle of 110 degrees deviated from a specular angle toward a measurement light when the measurement light on a surface of the multilayer coating film to be measured illuminates at an angle of 45 degrees with respect to an axis perpendicular to the surface of the multilayer coating film to be measured.

### Item 19.

The method for forming a multilayer coating film according to Item 17 or 18, wherein the colored base coating film has a lightness L* (45°) of 85 or more, the lightness L* (45°) indicating a lightness L* as measured for light received at an angle of 45 degrees deviated from a specular angle toward a measurement light when the measurement light illuminates on a surface to be measured at an angle of 45 degrees with respect to an axis perpendicular to the surface to be measured.

### Item 20.

The method for forming a multilayer coating film according to any one of Items 17 to 19, wherein the color pigment contains titanium oxide.

### Item 21.

The method for forming a multilayer coating film according to any one of Items 17 to 20, wherein the colored base paint (X) contains a base resin selected from the group consisting of an acrylic resin, a polyester resin, an epoxy resin, and a polyurethane resin.

### Item 22.

The method for forming a multilayer coating film according to any one of Items 17 to 21, wherein the colored base paint (X) contains a curing agent selected from the group consisting of an amino resin, a polyisocyanate compound, and a blocked polyisocyanate compound.

### Item 23.

The method for forming a multilayer coating film according to any one of Items 17 to 22, wherein the colored base coating film has a thickness of 5.0 to 40 μm on a dry film basis.

### Item 24.

The method for forming a multilayer coating film according to any one of Items 16 to 22, wherein the interference pigment contains at least one interference pigment selected from the group consisting of a metal-oxide-coated mica pigment and a metal-oxide-coated alumina flake pigment.

### Item 25.

The method for forming a multilayer coating film according to any one of Items 17 to 24, wherein the effect base paint (Y) further contains a rheology control agent.

### Item 26.

The method for forming a multilayer coating film according to Item 25, wherein the rheology control agent is at least one member selected from the group consisting of a silica-based fine powder, a mineral-based rheology control agent, a barium sulfate fine powder, a polyamide-based rheology control agent, an organic-resin fine-particle rheology control agent, a diurea-based rheology control agent, an urethane-associated rheology control agent, a polyacrylic-acid-based rheology control agent, and a cellulose-based rheology control agent.

### Item 27.

The method for forming a multilayer coating film according to Item 25 or 26, wherein the rheology control agent contains a cellulose nanofiber.

### Item 28.

The method for forming a multilayer coating film according to any one of Items 25 to 27, wherein the effect base paint (Y) contains a rheology control agent in an amount of 0.1 to 97 parts by mass, on a solids basis, per 100 parts by mass of the effect base paint (Y).

### Item 29.

The method for forming a multilayer coating film according to any one of Items 17 to 28, wherein the effect base paint (Y) further contains a resin component.

### Item 30.

The method for forming a multilayer coating film according to any one of Items 17 to 29, wherein the effect base paint (Y) further contains a surface-adjusting agent.

### Item 31.

The method for forming a multilayer coating film according to any one of Items 17 to 30, wherein the effect base paint (Y) has a solids content of 0.1 to 9 mass % when subjected to coating.

### Item 32.

The method for forming a multilayer coating film according to any one of Items 17 to 31, wherein the effect base coating film has a thickness of 1.6 to 4 μm on a dry film basis.

### Item 33.

The method for forming a multilayer coating film according to any one of Items 17 to 32, wherein the clear-coat paint (Z) contains a one-component clear-coat paint containing a base resin and a curing agent or a two-component clear-coat paint containing a hydroxy-containing resin and a polyisocyanate compound.

### EXAMPLES

The present invention is more specifically explained below with reference to Production Examples, Examples, and Comparative Examples. However, these Production Examples, Examples, and Comparative Examples are merely examples, and not intended to limit the scope of the present invention. The units “parts” and “%” in the Production Examples, Examples, and Comparative Examples are based on mass unless indicated otherwise. The film thickness of a coating film is based on a cured coating film.

### [1] Preparation of Substrate

A steel plate degreased and treated with zinc phosphate (JIS G 3141, size: 400 mm×300 mm×0.8 mm) was coated with Elecron GT-10 cationic electrodeposition paint (trade name; produced by Kansai Paint Co., Ltd.; a block polyisocyanate compound is used as a curing agent in an epoxy-resin polyamine-based cationic resin) by electrodeposition such that the coated film had a film thickness of 20 μm on a cured coating film basis. The coated film was heated at 170° C. for 20 minutes to allow the coated film to be crosslinked and cured, thereby forming an electrodeposition coating film.

The obtained electrodeposition coating film on the steel plate was coated with WP-523H N-8 (trade name; Kansai Paint Co., Ltd.; aqueous intermediate paint; the obtained intermediate coating film had a lightness L* (45°) of 80) by using air spray such that the film thickness was 30 μm on a cured coating film basis, and allowed to stand for 3 minutes, thereby forming an uncured intermediate coating film. This plate was determined to be a substrate.

### [2] Preparation of Paint

### Production of Hydroxy-Containing Acrylic Resin Emulsion (1)

### Production Example 1

70.7 parts of deionized water and 0.52 parts of Aqualon KH-10 (trade name; produced by DKS Co., Ltd.; emulsifier, active ingredient 97%) were placed into a reaction vessel equipped with a thermometer, a thermostat, a stirrer, a reflux condenser, and a dropping funnel, and mixed and stirred in a nitrogen stream, followed by heating to 80° C. Subsequently, 1% of the entire monomer emulsion described below and 5 parts of a 6% ammonium persulfate aqueous solution were introduced into the reactor, and the mixture was maintained at 80° C. for 15 minutes. Thereafter, the remaining monomer emulsion was added dropwise to the reaction vessel maintained at the same temperature for 3 hours. After completion of the dropwise addition, the mixture was aged for 1 hour. Thereafter, while 40 parts of a 5% 2-(dimethylamino)ethanol aqueous solution was gradually added to the reaction vessel, the reaction product was cooled to 30° C. and discharged while being filtered through a 100-mesh nylon cloth, thereby obtaining a hydroxy-containing acrylic resin emulsion (1) with a solids concentration of 45%. The obtained hydroxy-containing acrylic resin emulsion (1) had a hydroxy value of 43 mg KOH/g and an acid value of 12 mg KOH/g.

Monomer Emulsion: 50 parts of deionized water, 10 parts of styrene, 40 parts of methyl methacrylate, 35 parts of ethyl acrylate, 3.5 parts of n-butyl methacrylate, 10 parts of 2-hydroxy ethyl methacrylate, 1.5 parts of acrylic acid, 1.0 part of Aqualon KH-10, and 0.03 parts of ammonium persulfate were mixed with stirring, thereby obtaining a monomer emulsion.

### Production of Hydroxy-Containing Polyester Resin

### Production Example 2

174 parts of trimethylolpropane, 327 parts of neopentyl glycol, 352 parts of adipic acid, 109 parts of isophthalic acid, and 101 parts of 1,2-cyclohexanedicarboxylic anhydride were placed in a reaction vessel equipped with a thermometer, a thermostat, a stirrer, a reflux condenser, and a water separator, and the temperature was increased from 160° to 230° C. over a period of 3 hours. Thereafter, the temperature was maintained at 230° C. while the generated condensed water was distilled off with the water separator to allow the reaction to proceed until the acid value reached 3 mg KOH/g or less. 59 parts of trimellitic anhydride was added to this reaction product, and addition reaction was performed at 170° C. for 30 minutes, followed by cooling to 50° C. or less. 2-(dimethylamino)ethanol in an equivalent amount to acid groups was added thereto to neutralize the reaction product, and then deionized water was gradually added, thereby obtaining a hydroxy-containing polyester resin solution with a solids concentration of 45% and a pH of 7.2. The obtained hydroxy-containing polyester resin had a hydroxy value of 128 mg KOH/g, an acid value of 35 mg KOH/g, and a weight average molecular weight of 13,000.

### Production of Pigment Dispersion Paste

### Production Example 3

56 parts (solids: 25 parts) of the hydroxy-containing polyester resin solution obtained in Production Example 2, 100 parts of JR-806 (trade name; produced by Tayca Corporation, a rutile of titanium dioxide), 0.03 parts of carbon MA-100 (trade name; produced by Mitsubishi Chemical Corporation; carbon black), 15 parts of Bariace B-35 (trade name; produced by Sakai Chemical Industry Co., Ltd.; barium sulfate powder), 3 parts of MICRO ACE S-3 (trade name; produced by Nippon Talc Co., Ltd.; talc powder), and 5 parts of deionized water were mixed, and the mixture was adjusted to a pH of 8.0 with 2-(dimethylamino)ethanol. Subsequently, the obtained mixture was placed in a wide-mouth glass bottle, and glass beads (diameter: about 1.3 mm) as dispersion media were added thereto. The bottle was hermetically sealed, and dispersing was performed with a paint shaker for 30 minutes, thereby obtaining a pigment dispersion paste (P-1).

### Production of Colored Base Paint (X)

### Production Example 4

179.03 parts of the pigment dispersion paste (P-1) obtained in Production Example 3, 44.4 parts (solids: 20 parts) of the hydroxy-containing acrylic resin emulsion (1) obtained in Production Example 1, 78 parts (solids: 30 parts) of Bayhydur VPLS2310 (trade name; produced by Sumitomo Bayer Urethane Co., Ltd.; a blocked polyisocyanate compound, solids: 38%), and 72 parts (solids: 25 parts) of UCOAT UX-8100 (trade name; produced by Sanyo Chemical Industries, Ltd.; urethane emulsion, solids: 35%) were homogeneously mixed. Subsequently, UH-752 (trade name; produced by ADEKA Corporation; a thickening agent), 2-(dimethylamino)ethanol, and deionized water were added to the obtained mixture, thereby obtaining a colored base paint (X-1) with a pH of 8.0, a paint solids content of 48%, and a viscosity of 1500 mPa·s as measured with a Brookfield viscometer at 20° C. at a rotational speed of 6 rpm.

### Evaluation of Colored Base Coating Film

The lightness L* (45°) of a colored base coating film formed from the obtained colored base paint (X-1) was evaluated with MA-68II (trade name; produced by X-Rite). The colored base coating film was obtained by applying the colored base paint (X-1) to the substrate obtained in section [1] above such that the film thickness was 10 μm on a cured-coating-film basis by using an electrostatic rotary mini bell coater at a booth temperature of 25° C. and a humidity of 75%, allowing the film to stand at room temperature for 3 minutes, and then heating the film at 140° C. for 30 minutes in a hot-air circulating oven. The colored base coating film formed from the colored base paint (X-1) had a lightness L (45°) of 90.

### Production of Hydroxy-containing Acrylic Resin Emulsion (2)

### Production Example 5

130 parts of deionized water and 0.52 parts of Aqualon KH-10 were placed in a reaction vessel equipped with a thermometer, a thermostat, a stirrer, a reflux condenser, and a dropping funnel; and stirred and mixed in a nitrogen airstream, followed by heating to 80° C. Subsequently, 1% of the entire amount of the following monomer emulsion (1) and 5.3 parts of a 6% ammonium persulfate aqueous solution were placed in a reaction vessel and maintained at 80° C. for 15 minutes. Thereafter, the remaining monomer emulsion (1) was added dropwise into the reaction vessel maintained at the same temperature over a period of 3 hours. After completion of the dropwise addition, the mixture was aged for 1 hour. Subsequently, the monomer emulsion (2) described below was added dropwise over a period of 1 hour, followed by aging for 1 hour. Thereafter, while 40 parts of a 5% dimethylethanol amine aqueous solution was gradually added to the reaction vessel, the reaction product was cooled to 30° C. and discharged while being filtered through a 100-mesh nylon cloth, thereby obtaining an hydroxy-containing acrylic resin emulsion (2) having a solids concentration of 30%. The obtained hydroxy-containing acrylic resin emulsion (2) had a hydroxy value of 25 mg KOH/g and an acid value of 33 mg KOH/g.

Monomer emulsion (1): 42 parts of deionized water, 0.72 parts of Aqualon KH-10, 2.1 parts of methylenebisacrylamide, 2.8 parts of styrene, 16.1 parts of methyl methacrylate, 28 parts of ethyl acrylate, and 21 parts of n-butyl acrylate were mixed with stirring, thereby obtaining monomer emulsion (1).
Monomer emulsion (2): 18 parts of deionized water, 0.31 parts of Aqualon KH-10, 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate, and 9 parts of n-butyl acrylate were mixed with stirring, thereby obtaining monomer emulsion (2).

### Production of Water-soluble Acrylic Resin

### Production Example 6

35 parts of propylene glycol monopropyl ether were placed in a reaction vessel equipped with a thermometer, a thermostat, a stirrer, a reflux condenser, a nitrogen inlet tube, and a dropping funnel, and heated to 85° C. Subsequently, a mixture of 32 parts of methyl methacrylate, 27.7 parts of n-butyl acrylate, 20 parts of 2-ethylhexyl acrylate, 10 parts of 4-hydroxybutyl acrylate, 3 parts of hydroxypropyl acrylate, 6.3 parts of acrylic acid, 1 part of 2-acryloyloxyethyl acid phosphate, 15 parts of propylene glycol monopropyl ether, and 2.3 parts of 2,2′-azobis(2,4-dimethylvaleronitrile) was added dropwise thereto over a period of 4 hours. After completion of the dropwise addition, the mixture was aged for 1 hour. Subsequently, a mixture of 10 parts of propylene glycol monopropyl ether and 1 part of 2,2′-azobis(2,4-dimethylvaleronitrile) was further added dropwise thereto over a period of 1 hour. After completion of the dropwise addition, the mixture was aged for 1 hour. 7.4 parts of diethanolamine were further added thereto, thereby obtaining a water-soluble acrylic resin solution with a solids content of 55%. The obtained water-soluble acrylic resin solution had an acid value of 51 mg KOH/g and a hydroxy value of 52 mg KOH/g.

### Production of Effect Base Paint (Y)

### Production Example 7

67.5 parts of distilled water, 0.4 parts (solids: 0.4 parts) of Dynol-604 (trade name; produced by Evonik Industries AG; an acetylene diol-based surface-adjusting agent, solids: 100%), 2.6 parts (solids: 2.6 parts) of Xirallic T61-10 Micro Silver (trade name; produced by Merck; a titanium oxide-coated alumina flake pigment, average particle size: 11.8 μm), 0.7 parts (solids: 0.2 parts) of the hydroxy-containing acrylic resin emulsion (2) obtained in Production Example 5, 1.1 parts (solids: 0.5 parts) of the water-soluble acrylic resin obtained in Production Example 6, 31.4 parts (solids: 0.6 parts) of Rheocrysta (trade name; produced by DKS Co. Ltd.; cellulose nanofiber, solids: 2%), 0.4 parts (solids: 0.2 parts) of TINUVIN 479-DW(N) (trade name; produced by BASF; UV absorber, solids: 40%), 0.3 parts (solids: 0.1 parts) of TINUVIN 123-DW(N) (trade name; produced by BASF; a light stabilizer, solids: 50%), 0.005 parts of dimethylethanol amine, and 0.5 parts of ethylene glycol monobutyl ether were added to a stirring and mixing vessel, and mixed with stirring, thereby preparing an effect base paint (Y-1).

### Production Examples 8 to 18

The procedure of Production Example 7 was repeated except that the formulations shown in Table 1 were applied, thereby obtaining effect base paints (Y-2) to (Y-12).

TABLE 1
The values in parentheses indicate a solids content.

| Production Example No. | | | 7 | 8 | 9 | 10 | 11 | 12 |
|---|---|---|---|---|---|---|---|---|
| Effect Base Paint (V) | | | Y-1 | Y-2 | Y-3 | Y-4 | Y-5 | Y-6 |
| Formulation | Distilled Water | | 67.5 | 67.5 | 67.5 | 67.5 | 67.5 | 67.5 |
| | Surface- | Dynol-604 | 0.4 (0.4) | 0.4 (0.4) | 0.4 (0.4) | 0.4 (0.4) | 0.4 (0.4) | 0.4 (0.4) |
| | adjusting Agent | | | | | | | |
| | Effect Pigment | Xirallic T61-10 MicroSilver | 2.6 (2.6) | 5.3 (5.3) | | | | |
| | | Xirallic T60-10 CrystalSilver | | | 4.3 (4.3) | | | |
| | | (Note 1) | | | | | | |
| | | TWINCLEPEARL SXA-SO | | | | 2.8 (2.8) | | |
| | | (Note 2) | | | | | | |
| | | TWINCLEPEARL SXC-SO | | | | | 3.9 (3.9) | |
| | | (Note 3) | | | | | | |
| | | IRIODIN 121 Rutile | | | | | | 4.1 (4.1) |
| | | Lustre Satin (Note 4) | | | | | | |
| | | IRIODIN 111 Rutile | | | | | | |
| | | Fine Satin (Note 5) | | | | | | |
| | | METASHINE | | | | | | |
| | | SBE025RS-J5 (Note 6) | | | | | | |
| | Resin | Hydroxy Group-containing | 0.7 (0.2) | 0.7 (0.2) | 0.7 (0.2) | 0.7 (0.2) | 0.7 (0.2) | 0.7 (0.2) |
| | Component | Acrylic Resin Emulsion (2) | | | | | | |
| | | Water-soluble Acrylic Resin | 1.1 (0.5) | 1.1 (0.5) | 1.1 (0.5) | 1.1 (0.5) | 1.1 (0.5) | 1.1 (0.5) |
| | Rheology | Rheocrysta | 31.4 (0.6) | 31.4 (0.6) | 31.4 (0.6) | 31.4 (0.6) | 31.4 (0.6) | 31.4 (0.6) |
| | Control Agent | PRIMAL ASE-60 (Note 7) | | | | | | |
| | UV Absorber | TINUVIN 479-DW (N) | 0.4 (0.2) | 0.4 (0.2) | 0.4 (0.2) | 0.4 (0.2) | 0.4 (0.2) | 0.4 (0.2) |
| | Light | TINUVIN 123-DW (N) | 0.3 (0.1) | 0.3 (0.1) | 0.3 (0.1) | 0.3 (0.1) | 0.3 (0.1) | 0.3 (0.1) |
| | Stabilizer | | | | | | | |
| | pH Adjuster | Dimethylethanolamine | 0.005 | 0.005 | 0.005 | 0.005 | 0.005 | 0.005 |
| | Solvent | Ethylene Glycol | 0.5 | 0.5 | 0.5 | 0.5 | 0.5 | 0.5 |
| | | Monobutyl Ether | | | | | | |
| Properties | Solids Content (%) | | 4.4 | 6.8 | 5.9 | 4.6 | 5.6 | 5.7 |
| | Paint Viscosity B60 Value (mPa · s) | | 330 | 510 | 340 | 380 | 490 | 440 |
| | Amount of Effect Pigment Based on 100 parts | | 56.5 | 72.6 | 68.3 | 58.3 | 66.1 | 67.2 |
| | by mass of Solids of Effect Base Paint (Y) | | | | | | | |
| | (parts by mass) | | | | | | | |
| | Amount of Effect Pigment Based on 100 Parts | | 2.5 | 4.9 | 4.0 | 2.7 | 3.7 | 3.9 |
| | by Mass of Entire Amount of Effect Base | | | | | | | |
| | Paint (Y) (parts by mass) | | | | | | | |
| Production Example No. | | | 13 | 14 | 15 | 16 | 17 | 18 |
| Effect Base Paint (Y) | | | Y-7 | Y-8 | Y-9 | Y-10 | Y-11 | Y-12 |
| Formulation | Distilled Water | | 67.5 | 67.5 | 45.4 | 67.5 | 67.5 | 67.5 |
| | Surface- | Dynol-604 | 0.4 (0.4) | 0.4 (0.4) | 0.4 (0.4) | 0.4 (0.4) | 0.4 (0.4) | 0.4 (0.4) |
| | adjusting Agent | | | | | | | |
| | Effect Pigment | Xirallic T61-10 MicroSilver | 2.3 (2.3) | 2.5 (2.5) | 5.3 (5.3) | 5.3 (5.3) | 7.9 (7.9) | |
| | | Xirallic T60-10 CrystalSilver | | | | | | |
| | | (Note 1) | | | | | | |
| | | TWINCLEPEARL SXA-SO | | | | | | |
| | | (Note 2) | | | | | | |
| | | TWINCLEPEARL SXC-SO | | | | | | |
| | | (Note 3) | | | | | | |
| | | IRIODIN 121 Rutile | | | | | | |
| | | Lustre Satin (Note 4) | | | | | | |
| | | IRIODIN 111 Rutile | 0.5 (0.5) | | | | | |
| | | Fine Satin (Note 5) | | | | | | |
| | | METASHINE | | 0.3 (0.3) | | | | 4.5 (4.5) |
| | | SBE025RS-J5 (Note 6) | | | | | | |
| | Resin | Hydroxy Group-containing | 0.7 (0.2) | 0.7 (0.2) | 0.7 (0.2) | 0.7 (0.2) | 0.7 (0.2) | 0.7 (0.2) |
| | Component | Acrylic Resin Emulsion (2) | | | | | | |
| | | Water-soluble Acrylic Resin | 1.1 (0.5) | 1.1 (0.5) | 1.1 (0.5) | 1.1 (0.5) | 1.1 (0.5) | 1.1 (0.5) |
| | Rheology | Rheocrysta | 31.4 (0.6) | 31.4 (0.6) | 50.0 (1.0) | 21.0 (0.4) | 31.4 (0.6) | 31.4 (0.6) |
| | Control Agent | PRIMAL ASE-60 (Note 7) | | | | 0.8 (0.2) | | |
| | UV Absorber | TINUVIN 479-DW (N) | 0.4 (0.2) | 0.4 (0.2) | 0.4 (0.2) | 0.4 (0.2) | 0.4 (0.2) | 0.4 (0.2) |
| | Light | TINUVIN 123-DW (N) | 0.3 (0.1) | 0.3 (0.1) | 0.3 (0.1) | 0.3 (0.1) | 0.3 (0.1) | 0.3 (0.1) |
| | Stabilizer | | | | | | | |
| | pH Adjuster | Dimethylethanolamine | 0.005 | 0.005 | 0.005 | 0.005 | 0.005 | 0.005 |
| | Solvent | Ethylene Glycol | 0.5 | 0.5 | 0.5 | 0.5 | 0.5 | 0.5 |
| | | Monobutyl Ether | | | | | | |

| | | | | | | | |
|---|---|---|---|---|---|---|---|
| Properties | Solids Content (%) | 4.6 | 4.6 | 7.4 | 7.4 | 9.0 | 6.1 |
| | Paint Viscosity B60 Value (mPa · s) | 480 | 380 | 1130 | 330 | 550 | 420 |
| | Amount of Effect Pigment Based on 100 parts | 58.3 | 58.3 | 68.8 | 72.6 | 79.8 | 69.2 |
| | by mass of Solids of Effect Base Paint (Y) | | | | | | |
| | (parts by mass) | | | | | | |
| | Amount of Effect Pigment Based on 100 Parts | 2.7 | 2.7 | 5.1 | 5.4 | 7.2 | 4.2 |
| | by Mass of Entire Amount of Effect Base | | | | | | |
| | Paint (Y) (parts by mass) | | | | | | |

(Note 1):
Xirallic T60-10 Crystal Silver (trade name; produced by Merck; a titanium-oxide-coated alumina flake pigment, average particle size: 18.5 μm)
(Note 2):
TWINCLEPEARL SXA-SO (trade name; produced by Nihon Koken Kogyo Co., Ltd.; a titanium-oxide-coated synthetic mica pigment, average particle size: 10.7 μm)
(Note 3):
TWINCLEPEARL SXC-SO (trade name; produced by Nihon Koken Kogyo Co., Ltd.; a titanium-oxide-coated synthetic mica pigment, average particle size: 15.5 μm)
(Note 4):
IRIODIN 121 Rutile Lustre Satin (trade name; produced by Merck; a titanium-oxide-coated natural mica pigment, average particle size: 9.7 μm)
(Note 5):
IRIODIN 111 Rutile Fine Satin (trade name; produced by Merck; a titanium-oxide-coated natural mica pigment, average particle size: 5.8 μm)
(Note 6):
METASHINE SBE025RS-J5 (trade name; produced by Nippon Sheet Glass Co., Ltd.; a titanium-oxide-coated glass flake, average particle size: 25.0 μm)
(Note 7):
PRIMAL ™ ASE-60 (trade name; produced by Dow Chemical Company, polyacrylic acid rheology modifier, aqueous dispersion having solid content of 28 wt %).

### Production of Test Plate

### Example 1

The colored base paint (X-1) obtained in Production Example 4 was electrostatically applied to the substrate prepared in section [1] to give a cured film thickness of 10 μm with a rotary-atomization bell-shaped coater, and the resulting film was allowed to stand for 3 minutes, thereby forming a colored base coating film with a lightness L* (45°) of 90. Further, the effect base paint (Y-1) obtained in Production Example 7 was applied to the colored base coating film with a robot bell (produced by ABB) at a booth temperature of 25° C. and a humidity of 75% to form a coating film with a thickness of 2.7 μm on a dry film basis. The film was allowed to stand for 3 minutes and then preheated at 80° C. for 3 minutes, thereby forming an effect base coating film. Subsequently, a clear-coat paint (Z-1), KINO6510, (trade name; produced by Kansai Paint Co., Ltd.; a hydroxy/isocyanate curable acrylic-urethane resin-based two-component organic solvent-based paint) was applied to the effect base coating film with a robot bell (produced by ABB) at a booth temperature of 25° C. and a humidity of 75% to form a coating film with a thickness of 35 μm on a dry film basis, thereby forming a clear-coat coating film. After coating, the film was allowed to stand at room temperature for 7 minutes, and then heated in a hot-air circulating oven at 140° C. for 30 minutes to simultaneously dry the multilayer coating film, thereby preparing a test plate.

The film thickness of the dry effect base coating film was calculated from the following formula. The same applies to the following Examples.

x=sc/sg/S*10000
x: film thickness [μm]
sc: application solids content [g]
sg: specific gravity of coating film [g/cm³]
S: area of evaluated application solids content [cm²]

### Examples 2 to 10 and Comparative Examples 1 to 4

The procedure of Example 1 was repeated except that the paint and film thickness shown in Table 2 were applied, thereby obtaining test plates.

TABLE 2

| | Examples | | | | | | | | | | Comparative Examples | | | |
|---|---|---|---|---|---|---|---|---|---|---|---|---|---|---|
| | 1 | 2 | 3 | 4 | 5 | 6 | 7 | 8 | 9 | 10 | 1 | 2 | 3 | 4 |
| Colored Base Paint (X) | X-1 | X-1 | X-1 | X-1 | X-1 | X-1 | X-1 | X-1 | X-1 | X-1 | X-1 | X-1 | X-1 | X-1 |
| Effect Base Paint (Y) | Y-1 | Y-2 | Y-3 | Y-4 | Y-5 | Y-6 | Y-7 | Y-8 | Y-9 | Y-10 | Y-1 | Y-11 | Y-3 | Y-12 |
| Thickness of Effect Base | 2.7 | 1.7 | 2.7 | 2.7 | 2.7 | 2.7 | 2.7 | 2.7 | 2.2 | 1.7 | 0.9 | 1.3 | 0.9 | 2.7 |
| Coating Film (μm) | | | | | | | | | | | | | | |
| Y Value (Y5) | 394 | 341 | 627 | 329 | 635 | 312 | 404 | 437 | 377 | 356 | 425 | 215 | 643 | 258 |
| 45° Sparkle Area Sa | 3.7 | 8.4 | 12.0 | 1.9 | 7.2 | 9.7 | 2.1 | 6.4 | 4.1 | 5.6 | 1.4 | 13.4 | 3.9 | 20.9 |
| 15° Sparkle Area Sa | 6.1 | 7.0 | 24.3 | 2.0 | 23.5 | 5.9 | 5.4 | 8.6 | 11.9 | 13.8 | 11.6 | 9.7 | 32.5 | 25.5 |
| Ratio of 15° Sparkle Area | 1.6 | 0.8 | 2.0 | 1.0 | 3.3 | 0.6 | 2.5 | 1.3 | 2.9 | 2.5 | 8.4 | 0.7 | 8.3 | 1.2 |
| Sa to 45° Sparkle Area Sa | | | | | | | | | | | | | | |
| Lightness L* (110°) Value | 83 | 81 | 79 | 82 | 80 | 80 | 82 | 82 | 84 | 84 | 89 | 86 | 85 | 83 |

### Evaluation of Coating Film

The test plates obtained in the above manner were evaluated on the following items. Table 2 illustrates the results.

### Measurement of Y Value Representing Luminance

Y value (Y5): A luminance Y value (Y5) in the XYZ color space was calculated based on a spectral reflectance measured for light that was received at an angle of 5 degrees deviated from the specular angle toward a measurement light when the measurement light illuminates the surface of an object to be measured at an angle of 45 degrees with respect to the axis perpendicular to the surface of the object. The measurement and the calculation were performed using a GCMS-4 goniometer (trade name; Murakami Color Research Laboratory Co., Ltd.).
Measurement of Sparkle area Sa
45° sparkle area Sa: The 45° sparkle area Sa was determined by disposing a CCD chip for taking an image of the surface of an object to be measured in the direction perpendicular to the planar direction of the surface of the object to be measured, taking images of the surface of the object with light illuminated on the surface of the object at an angle of 45 degrees with respect to the direction perpendicular to the planar direction, by using the CCD chip, and analyzing the obtained images with an image processing algorithm that uses a histogram of brightness levels. The measurement was performed with a multi-angle colorimeter (trade name: BYK-mac i; produced by BYK).
15° sparkle area Sa: The 15° sparkle area Sa was determined by disposing a CCD chip for taking an image of the surface of an object to be measured in the direction perpendicular to the planar direction of the surface of the object, taking images of the surface of the object with light illuminated on the surface of the object at an angle of 15 degrees with respect to the direction perpendicular to the planar direction, by using the CCD chip, and analyzing the obtained images with an image processing algorithm using a histogram of brightness levels. The measurement was performed with a multi-angle colorimeter (trade name: BYK-mac i; produced by BYK).
Ratio of 15° sparkle area Sa to 45° sparkle area Sa: This ratio was determined from the following formula with the measurement results of the 45° sparkle area Sa and 15° sparkle area Sa. Formula: 15° sparkle area Sa/45° sparkle area Sa

### Measurement of Lightness L* (110°)

The lightness L* (110°) value used here was calculated from the spectral reflectance measured with an MA-68II multi-angle spectrophotometer (trade name; produced by X-Rite, Inc.).

What is claimed is:

1. A multilayer coating film comprising on a substrate in the following sequence
a color-pigment-containing colored base coating film,
an interference-pigment-containing effect base coating film, and
a clear-coat coating film,
the multilayer coating film having a Y value (Y5) of 300 or more,
the Y value indicating a luminance in an XYZ color space based on a spectral reflectance measured for light that is received at an angle of 5 degrees deviated from a specular angle toward a measurement light when the measurement light illuminates a surface of the multilayer coating film to be measured at an angle of 45 degrees with respect to an axis perpendicular to the surface of the multilayer coating film to be measured,
the multilayer coating film having a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction,
the imaging device for taking the images of the surface of the multilayer coating film being disposed in the direction perpendicular to the planar direction of the surface of the multilayer coating film to be measured.

2. The multilayer coating film according to claim 1, which has a lightness L* (110°) of 78 or more, wherein the lightness L* (110°) indicates a lightness L as measured for light received at an angle of 110 degrees deviated from a specular angle toward a measurement light when the measurement light is illuminated to the surface of the multilayer coating film to be measured at an angle of 45 degrees with respect to an axis perpendicular to the surface of the multilayer coating film to be measured.

3. The multilayer coating film according to claim 1, wherein the colored base coating film has a lightness L* (45°) of 85 or more, wherein the lightness L* (45°) indicates a lightness L* as measured for light received at an angle of 45 degrees deviated from a specular angle toward a measurement light when the measurement light is illuminated to a surface to be measured at an angle of 45 degrees with respect to an axis perpendicular to a surface to be measured.

4. The multilayer coating film according to claim 1, wherein the effect base coating film has a thickness of 1.6 to 4 μm on a dry film basis.

5. A method for forming a multilayer coating film comprising the following steps (1) to (4):
step (1) of applying a color-pigment-containing colored base paint (X) to a substrate to form a colored base coating film,
step (2) of applying an interference-pigment-containing effect base paint (Y) to the colored base coating film to form an effect base coating film,
step (3) of applying a clear-coat paint (Z) to the effect base coating film to form a clear-coat coating film, and
step (4) of separately or simultaneously heating the colored base coating film formed in step (1), the effect base coating film formed in step (2), and the clear-coat coating film formed in step (3) to cure the films,
wherein
the multilayer coating film has a Y value (Y5) of 300 or more, the Y value indicating a luminance in an XYZ color space based on a spectral reflectance measured for light that is received at an angle of 5 degrees deviated from a specular angle toward a measurement light when the measurement light is illuminated to a surface of the multilayer coating film to be measured at an angle of 45 degrees with respect to an axis perpendicular to the surface of the multilayer coating film to be measured; and
the multilayer coating film has a ratio of a 15° sparkle area Sa to a 45° sparkle area Sa of 7 or less,
the 45° sparkle area Sa being measured from an image obtained by photographing the surface of the multilayer coating film to be measured with an imaging device with light illuminated on the surface of the multilayer coating film to be measured at an angle of 45 degrees with respect to a direction perpendicular to a planar direction of the surface of the multilayer coating film to be measured,
the 15° sparkle area Sa being measured from an image obtained by photographing the surface of the multilayer coating film to be measured with the imaging device with light illuminated on the surface of the multilayer coating film to be measured at an angle of 15 degrees with respect to the direction perpendicular to the planar direction,
the imaging device for taking the images of the surface of the multilayer coating film being disposed in the direction perpendicular to the planar direction of the surface of the multilayer coating film to be measured.

6. The method for forming a multilayer coating film according to claim 5, wherein the multilayer coating film has a lightness L* (110°) of 78 or more, the lightness L* (110°) indicating a lightness L* as measured light received at an angle of 110 degrees deviated from a specular angle toward a measurement light when the measurement light is illuminated on the surface of the multilayer coating film to be measured at an angle of 45 degrees with respect to an axis perpendicular to the surface of the multilayer coating film to be measured.

7. The method for forming a multilayer coating film according to claim 5, wherein the colored base coating film has a lightness L* (45°) of 85 or more, the lightness L* (45°) indicating a lightness L as measured light received at an angle of 45 degrees deviated from a specular angle toward a measurement light when the measurement light is illuminated on a surface to be measured at an angle of 45 degrees with respect to an axis perpendicular to the surface to be measured.

8. The method for forming a multilayer coating film according to claim 5, wherein the effect base paint (Y) has a solids content of 0.1 to 9 mass % when subjected to coating.

9. The method for forming a multilayer coating film according to claim 5, wherein the effect base coating film has a thickness of 1.6 to 4 μm on a dry film basis.
